(19) United States
(12) Patent Application Publication
(10) Pub. No.: US 2015/0228174 A1
(43) Pub. Date: Aug. 13, 2015

(54) Survival backpack with notification system

(71) Applicant: Sparq LLC, Denver, CO (US)

(72) Inventor: Timothy Bauer, Denver, CO (US)

(21) Appl. No.: 14/622,570

(22) Filed: Feb. 13, 2015

Related U.S. Application Data
(60) Provisional application No. 61/939,647, filed on Feb. 13, 2014.

(51) Int. Cl. G08B 21/02; A45F 3/00; A45F 4/02; H04W 4/02

(52) U.S. Cl. CPC G08B 21/02; H04W 4/02; A45F 3/00; A45F 4/02; A45F 2003/001; A45F 2003/003

(57) ABSTRACT

A survival backpack has an airbag and emergency notification system. Upon triggering of the airbag, the system is activated and configured to connect with a third party communication device either immediately or upon expiration of a countdown sequence. The system may emit an audible alert to prompt the user to cancel the connection if rescue is not needed. When connected, the system may transmit a message or other information to another which may help in recovering or assisting the user of the backpack. The system may provide location information, which allows the third party communication device to dispatch emergency responders, and may enable two-way communication with local or remote rescuers.

### CROSS REFERENCE TO RELATED APPLICATIONS

This application claims the benefit of priority of U.S. Application No. 61/939,647, filed Feb. 13, 2014 and entitled “Avalanche Backpack with Inflatable Airbag, Locator, and Notification System,” which is hereby incorporated by reference as though fully set forth herein.

### TECHNICAL FIELD

The technology described herein relates to a survival backpack having a notification system and airbag system.

### BACKGROUND

Backcountry ski and snowboard gear is a rapidly growing segment of the snow sports industry. Backcountry ski terrain is generally defined as areas outside the bounds of ski resorts and therefore is an area that is not regularly patrolled. Further, backcountry terrain is not as closely monitored and maintained with respect to avalanche risk as areas within the perimeters of a ski resort. As such, accidents in these areas can be especially dangerous because the terrain is less predictable and, if an accident happens, help is not easily notifiable, accessible, or quick to respond. For a user buried in an avalanche, survival rates drop drastically if the user is not recovered within 10 minutes. Clearly, the speed of emergency response is essential for rescue, medical treatment, and ultimate survival of the user.

Unintentionally triggering an avalanche, being caught in the snowslide, impacts with debris, and burial under the snow are particular concerns when enjoying backcountry terrain. Often the user has only seconds to realize the avalanche has started and take corrective action, if possible. In the case of a user-triggered avalanche, the user often will be immersed in the snowslide with few or no options to escape.

Over the past decade, backcountry skiers, snowboarders, and other snow enthusiasts have increasingly had access to snow gear intended to reduce the risk of injury and burial during an avalanche. Backpacks and vests which contain inflatable airbags intended for avalanche safety and rescue are currently available. When a user is caught in an avalanche slide, the user activates the airbag system whereby a compressed gas at high pressure is used to inflate the airbags. The larger surface area created by the inflated airbag results in increase buoyancy, thus helping the user stay closer to the surface of the snow as the avalanche propagates. This buoyancy helps keep the user away from any debris flowing with the snowslide, objects under the slide such as trees or rocks, and ultimately helps prevent the user from being buried when the avalanche settles. In the instance of burial, the airbag creates moving room for the user when the airbag deflates, leaving a nominally breathable air pocket behind which can also enable the user to begin to dig out of the snow.

Being caught in or buried by an avalanche slide can be dangerous for several reasons. In addition to suffocation risk, there is a high risk of the user sustaining serious trauma from objects carried within the slide or stationary under the surface of the snow (e.g., rocks, trees). As a result, the user often sustains injuries such as broken bones or is knocked unconscious, making it difficult or impossible for them to help extract themselves from the snow or call for help. In addition to increasing buoyancy, the inflated airbag helps reduce the risk of trauma caused by the user impacting objects under the surface of the snow by providing additional padding between the user and the environment.

Avalanche transceivers or beacons are standard equipment for backcountry skiers and snowboarders. The transceiver emits a signal that is receivable by another user's transceiver when placed in “search” mode. The signal helps an emergency responder or ski partner obtain relative directional location and depth information for a buried user who is wearing a transceiver. However, the range of the emitted signal is limited and an active responder needs to be searching an immediate area for the signal to be helpful.

The information included in this Background section of the specification, including any references cited herein and any description or discussion thereof, is included for technical reference purposes only and is not to be regarded subject matter by which the scope of the invention as defined in the claims is to be bound.

### SUMMARY

In one example, the present disclosure is related to a survival backpack comprising an airbag system, where the airbag system has at least one airbag, an airbag trigger that deploys the airbag when actuated, a communication device, and a rescue system controller. The survival backpack may further comprise a communication device operatively connected to the rescue system controller and comprising at least one transceiver configured to transmit and receive a data signal, wherein the rescue system controller is connected to the airbag trigger and configured to identify when the airbag trigger is actuated. Upon activation of the airbag system by a user actuating the airbag trigger, the rescue system controller causes the communication device to transmit the data signal for reception by a third party communication device.

In another example, the present disclosure is related to an emergency notification method performed by a rescue system in a survival backpack, the backpack having a deployable airbag, an airbag trigger that deploys the airbag when actuated, a rescue system controller, an activation switch coupled to the airbag trigger and switchably connected to the rescue system controller, a sound emitting device connected to the rescue system controller, a communication device connected to the rescue system controller and having at least one transceiver configured to establish a connection to a third party communication device, wherein the emergency notification method comprises determining by the rescue system controller in response to connection with the activation switch if the airbag has been activated, and when the airbag has been activated, controlling by the rescue system controller the communication device to establish a connection with the third party communication device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various examples of the invention and illustrated in the accompanying drawings.

### BRIEF DESCRIPTION OF THE DRAWINGS

FIG. 1A depicts a user wearing an example of a survival backpack having an emergency notification system.

FIG. 1B is an isometric view of the back of the backpack of FIG. 1A.

FIG. 1C is an isometric view of the front of the backpack of FIG. 1A.

FIG. 2A is an isometric view of the front of the backpack

FIG. 2B is an enlarged view of FIG. 2A showing additional details of the backpack.

FIG. 3A depicts components of the airbag system for use in the backpack of FIG. 1A.

FIG. 3B is an enlarged views the airbag system of FIG. 3A.

FIG. 4 is an isometric view of the back of the backpack after the airbag system of FIG. 3 has been triggered.

FIG. 5 is a schematic diagram of the details of the rescue system controller for use in the airbag system of FIG. 3.

FIGS. 6A-6B various steps of the emergency notification system for use in the backpack of FIG. 1A.

FIG. 7 is a flow chart illustrating exemplary process flow details for the emergency notification system of FIGS. 6A-6B.

FIG. 8 is a flow chart illustrating exemplary flow details for connecting to a third party device according to the emergency notification system of FIG. 7.

### DETAILED DESCRIPTION

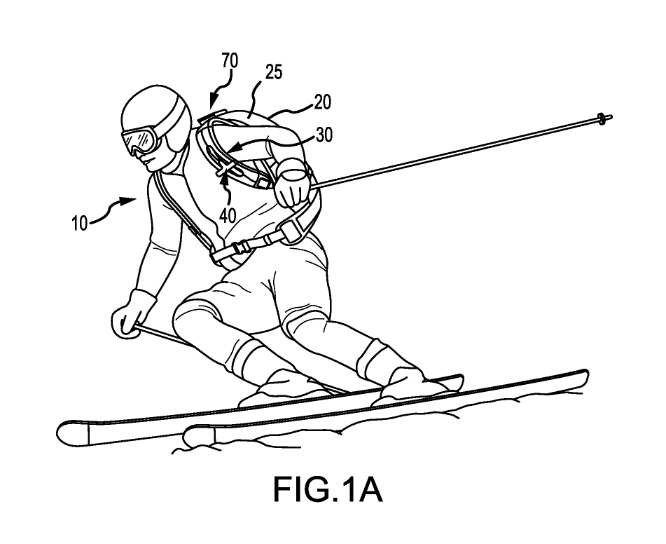

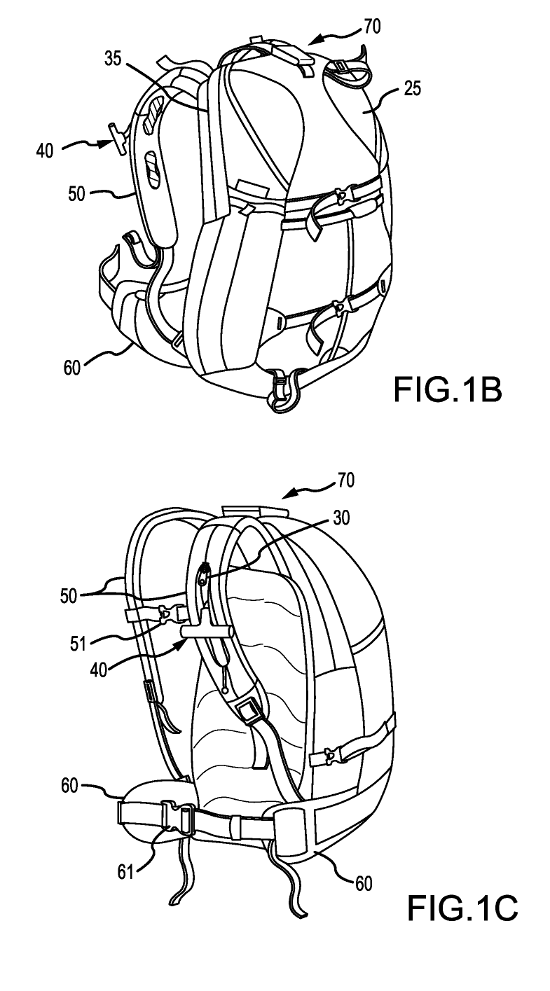

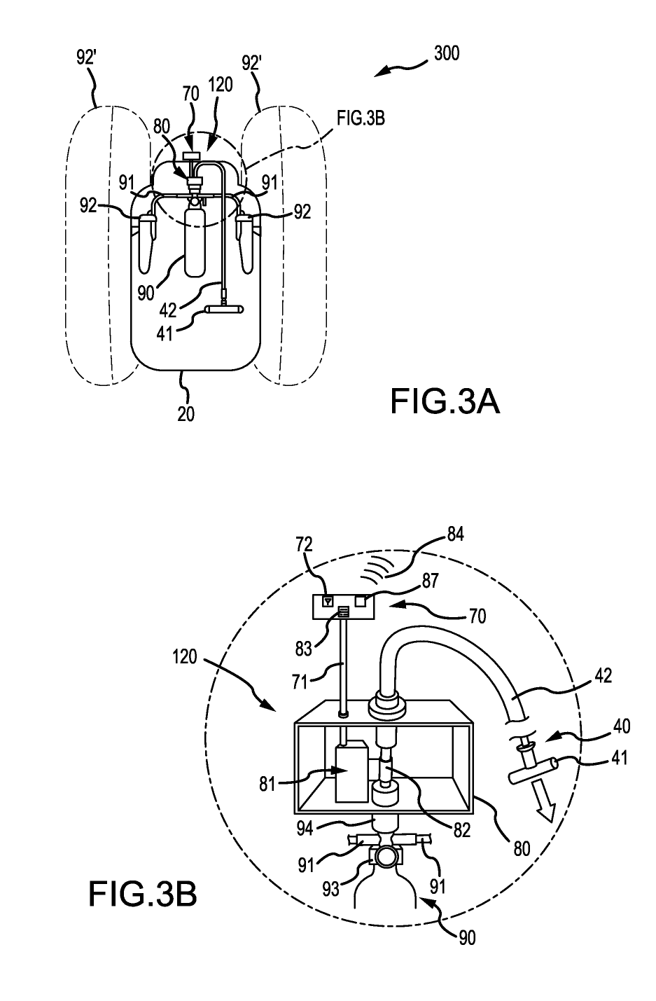

In FIG. 1A, a backpack 20 having an emergency notification system as set forth in the description below. In one example, the backpack 20 may have a main compartment 25 and secondary compartment 35, and may be configured to be worn by a user 10. In some examples, the user 10 may be a backcountry skier, hiker, or other user 10. As seen best in FIGS. 1B-1C, the backpack 20 may have an airbag trigger pouch 30 for containing an airbag trigger 40, an airbag trigger handle 41, and trigger cable 42. In one example, the backpack 20 may have one or more secondary compartments 35. The airbag system 300 (discussed below with respect to FIG. 3) may be at least partially contained in the secondary compartments 35.

In some examples, the secondary compartments 35 are provided on opposing lateral sides of the backpack 20. In some examples, the secondary compartments 35 may contain airbag(s) 92 (see FIG. 3). Accordingly, the secondary compartments may also be referred to as airbag compartments 35. The airbag compartments 35 may be provided in any suitable location, including under the main compartment 25, or above and around an upper portion of the main compartment 25. In some examples, the main or primary compartment 25 may be used by the user for storage of gear, equipment, food, and the like. In other examples, the main or primary compartment 25 may store at least a portion of the airbag system 300.

With continuing reference to FIGS. 1B-1C, the backpack 20 may be provided with upper straps 50 having an upper strap buckle 51, and lower straps 60 including a lower strap buckle 61. In one example, a communication device 70 may be provided on an upper portion of the main compartment 25. Alternatively, the communication device 70 may be placed within a compartment of the backpack 20, such as in a main compartment 25, to protect it from the elements. Further, in some examples, the communication device 70, rescue system controller 100, airbag system 300 (discussed below), or rescue and emergency notification system 100 (discussed below with respect to FIGS. 3A, 35, 5, 7, and 8) as a whole may be water-resistant, impact-resistant, and/or freeze-resistant in order to ensure continued functionality in demanding or harsh environments.

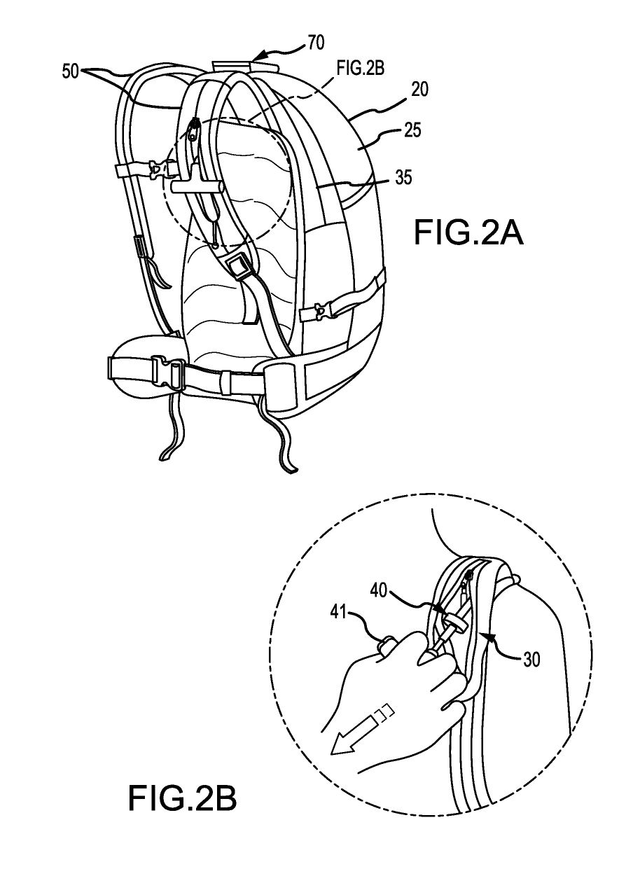

FIG. 2A is an isometric view of the backpack 20 of FIG. 1. FIG. 2B shows an enlarged subsection of FIG. 2A depicting details of the airbag trigger 40 in the trigger pouch 30. The user 10 may grasp or otherwise engage the trigger handle 41 in order to operate the airbag trigger 40. In some examples, as shown best in FIG. 3B and discussed below, a cable 42 may operatively connect the trigger 40 with the switch 82 of the airbag system 300. Though illustrated as a T-shaped handle 41 in FIGS. 1 and 2, in some examples the airbag trigger 40 may be a button, lever, or other suitable device configured for activation of the airbag system 300. The user may access the airbag trigger pouch 30 by using an appropriate fastener, such as a zipper, hook-and-loop fasteners (e.g., Velcro), buttons, or the like.

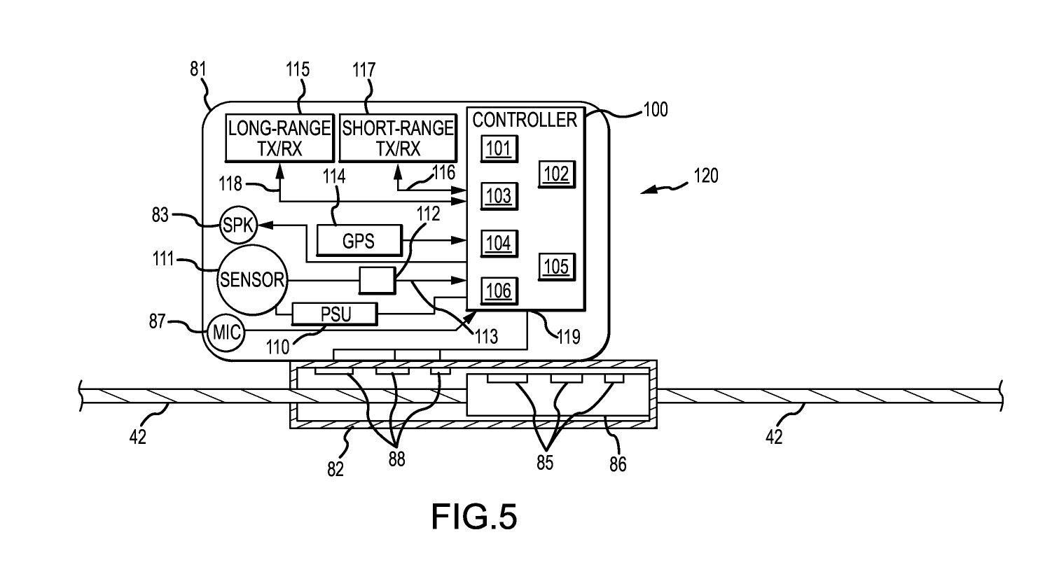

Turning to FIG. 3, a simplified view of airbag system 300 is shown. In one example, as shown in FIG. 3A, the backpack 20 may further include an airbag system housing 80. As seen in the enlarged view of FIG. 3B, the airbag trigger 40 may a T-shaped or ergonomically shaped handle 41. In some examples, the trigger handle 41 may be connected to the system housing 80 by a cable 42. The housing 80 may house several components for operating the airbag system 300 of the backpack 20, including a main controller housing 81 which encloses the rescue system controller 100, discussed in greater detail below with respect to FIG. 5. The system housing 80 further contains an electrical switch 82 and has connections 94 for a compressed gas canister 90 and a direct connection via electrical conduit 71 between the airbag system housing 80 and communication device 70. Though depicted as directly connected via electrical conduit 71, the controller housing 81 and satellite communication device 70 may be connected wirelessly, such as via radio frequency (RF), Bluetooth, WiFi, Zigbee, optical, or other protocols.

With continuing reference to FIG. 3, the communication device 70 may have an antenna 72 configured for communication over existing protocols, such as microwave, radio frequency, and the like. In some examples, the communication device 70 may be generally located on the exterior or upper portion of the backpack, which may enable more reliable communication reception. In some examples, a sound emitting device 83 and microphone 87 may also be positioned along with the antenna 72 on an exterior of the bag. However, the location of the antenna 72, sound emitting device 83, and/or microphone 87 is exemplary, and in some examples components may be placed within the backpack 20 such as within main compartment 25. Additionally, sound emitting device 83 and microphone 87 may be separately provided on the backpack 20 or may be integrated with communication device 70, and the sound emitting device 83 and microphone 87 may be configured to facilitate two-way communication between a user 10 and a third party communication device. As discussed above, the electrical conduit 71 of the satellite communication device is functionally replaced by a wireless transmission protocol, which in one example may be Bluetooth, WiFi, or the like.

A compressed gas canister 90 contains a gas at a pressure much greater than atmospheric pressure. In one example, the gas is breathable air so that when the airbag deflates in a emergency or burial situation, it will leave a pocket of air the user 10 can use to breathe while attempting to extract from the snow and/or while help is being contacted and dispatched. Other gases can be used in order to satisfy particular considerations such as weight and safety. The compressed gas canister 90 may be provided with a pressure gauge 93 and is connected to the housing 80 in a conventional manner. The canister has pneumatic airbag inflation tubes 91 which are operatively connected to airbags 92 generally disposed on opposing sides of the backpack 20. Upon activation via the airbag trigger 40, the airbags 92 deploy through exterior openings of the backpack 20 and become several times larger in size, as depicted generally at 92′. It is noted that the configuration shown in FIG. 3 is exemplary and relative changes to the design and operation are possible without departing from the scope of the present disclosure.

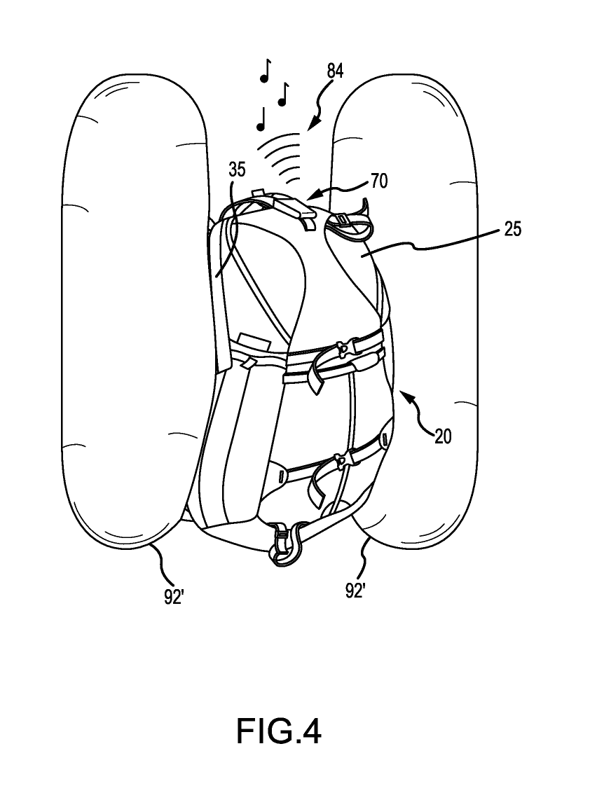

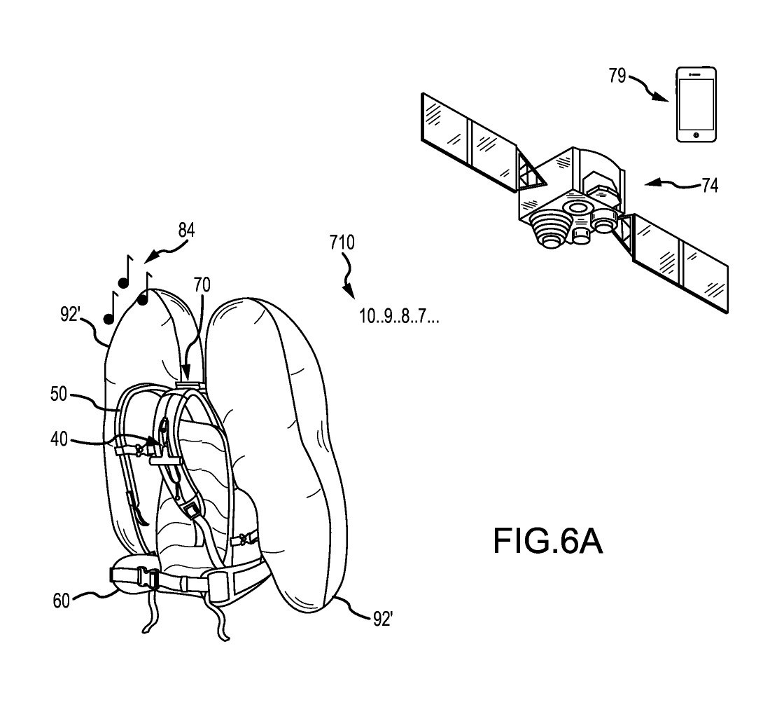

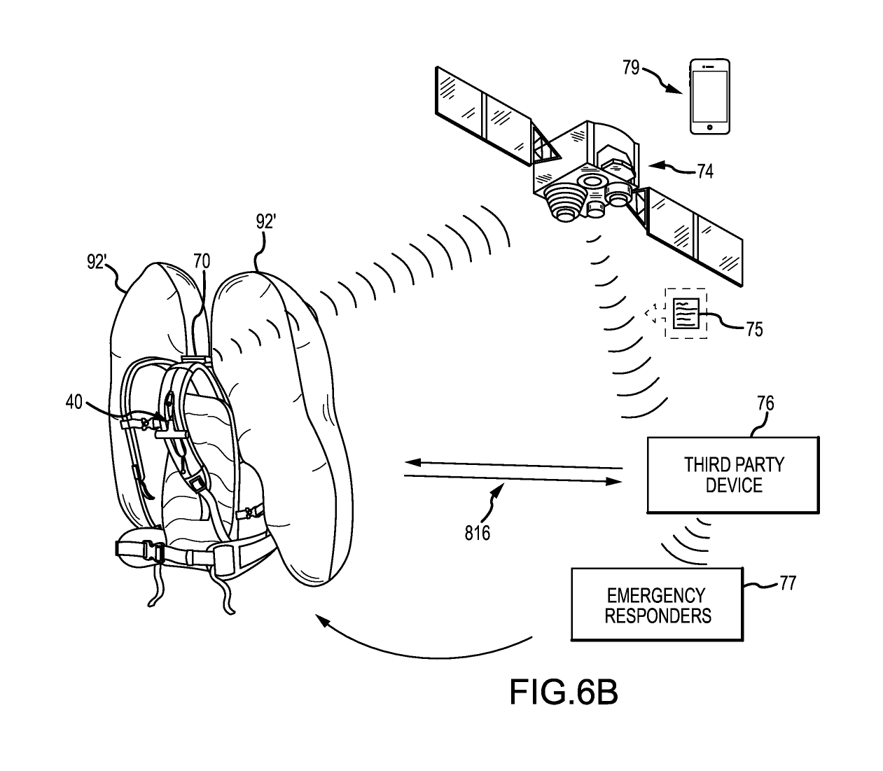

FIG. 4 is an isometric view of the exterior of the backpack 20 discussed above after the airbag system 300 has been triggered and the emergency notification system 120 has been activated. The audible alert 84 may be emitted by the sound emitting device 83 so that others nearby can easily determine the location of a user 10. Additionally, the alert 84 indicates to the user 10 that the emergency notification system countdown and protocol has started. This enables the user 10 to cancel the communication device 70 from contacting authorities, such as in a case where the airbag system 300 was accidentally triggered, or the user 10 has been able to escape or extract from the snow. The emergency notification system 120 and protocol is discussed in more detail below with respect to FIGS. 6-8.

An example of the airbag system housing 80 and electrical switch 82 is shown in greater detail in FIG. 5. The electrical switch 82 contains an electrical switch carrier 86 having a plurality of electrical switch contacts 85 operatively connected to the airbag trigger cable 42. One or more electrical controller contacts 88 may also be positioned on the electrical switch housing 82 and are connected to respective components within the main controller housing 81 as further described below. When the user 10 triggers the airbag by pulling on the cable 42, the switch carrier 86 slides within the switch housing 82 and the electrical contacts 85 on the electric switch carrier are placed in alignment with the electrical controller contacts 88 on the electric switch housing 82, thus completing an electrical circuit.

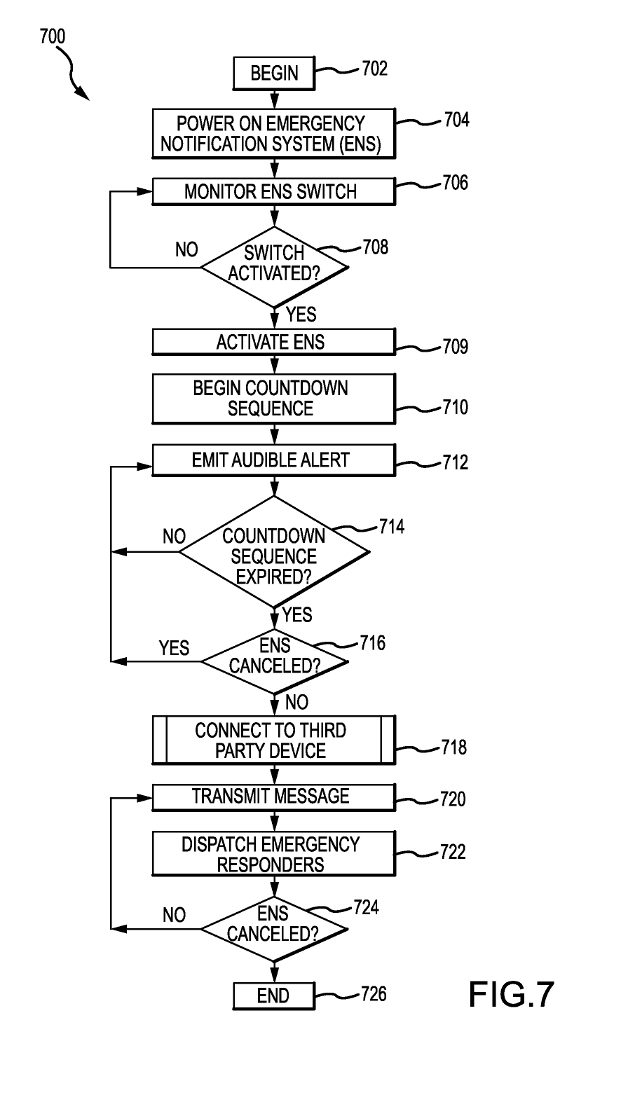

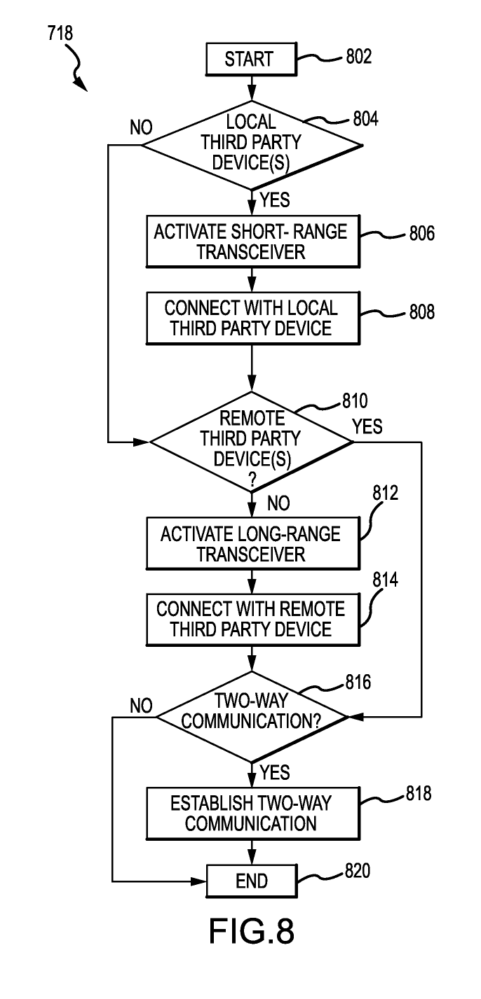

The internal layout of the main controller housing 81 as shown in FIG. 5 is exemplary and may contain several computer and microcontroller components configured to operate as discussed in the present disclosure. The interoperation or physical layout of the parts can be adjusted without departing from the scope of the present disclosure. With continuing reference to FIG. 5, the rescue system controller 100 may be an integrated microcontroller including a central processing unit 103, a storage device 102, a data logger 104, a signal processor 101, and a signal conditioner 106. The rescue system controller 100 may have processing logic that is optionally configured as firmware (e.g., in the CPU 103), software (e.g., stored in the storage device 102), and/or other individual components. The actions undertaken by the emergency notification system 120, described below with respect to FIGS. 7 and 8, may be implemented as processing logic for the CPU 103. In some examples, the emergency notification system 120 and protocol may be stored on the storage device 102. The storage device 102 may be substantially any suitable storage device, such as solid state storage, volatile or non-volatile memory, a hard drive, CD or DVD, and the like.

The rescue system controller 100 has a signal input 119 for receiving, for example, trigger signals from the electrical controller contacts 88. The rescue system controller 100 is further connected to a power supply 110 and a sensor 111. In some examples, the power supply 110 may be in the form of a lithium-ion polymer battery, or other suitable type of battery. In a preferred example, the power supply 110 may be a rechargeable battery. In other examples, the backpack 20 may be equipped with a small solar panel that is connected with the power supply 110 to provide charging when the backpack 20 is exposed to sunlight. In addition to providing power to the rescue system controller 100, the power supply 110 may also power the sensor 111, a location device 114, which in some examples may be a global positioning satellite (GPS) receiver, a long-range transceiver 115 and a short-range transceiver 117. Though depicted as separate elements, transmitted and receiver 115, 117 may be replaced by a single transceiver component capable of transmitting and receiving both long range and short range communications. In some examples, the location device 114 may determine a user's location using a GPS satellite network, triangulation algorithms, time of flight algorithms, or the like. In some examples, the long-range transceiver 115 may operate on satellite, microwave, cell phone, GSM, CDMA, or radio frequency (RF) protocols and may be powerful enough to transmit and receive data and signals over a long range. In some examples, the short-range transceiver 117 may operate on local area wireless protocols, WiFi, WiMax, Zigebee, Bluetooth, and the like.

The power supply may power the respective components either directly or indirectly through the rescue system controller 100. The rescue system controller 100 may receive input of a first signal 113 from the sensor 111 via a first signal conditioner 112, which may be a digital signal conditioner (DSC). The rescue system controller 100 may further receive input signals corresponding to a GPS location signal from the GPS unit 114 and a second signal 116 from a receiver 117. The rescue system controller 100 may output a third signal 118 to the transmitter 115.

In one example, the communication device 70 connects with the rescue system controller 100 via device conduit 71 and is thereby directly activated by triggering of the electrical switch 82. Alternatively, this connection can be made wirelessly via Bluetooth or other standard wireless transmission protocols.

In some examples, the GPS unit 114 and the satellite communication device 70 are operatively connected and capable of transmitting and receiving signals to and from a Bluetooth or other wireless transmission module, a cellular phone, a GPS network, a SPOT GPS tracking and messaging network, a cellular tower network, an internet terminal, and the like.

Turning now to FIGS. 6A and 6B, components and actions of the airbag system 300 and rescue or emergency notification system 120 are shown in more detail after activation. In FIG. 6A, the user 10 has activated the airbag trigger 40 by pulling the trigger handle 41 and the cable 42, causing the switch contacts 85 and the rescue system controller 100 contacts 88 to align. The resulting electrical connection signals to the rescue system controller 100 to deploy the airbags 92′ and initiate the emergency notification system 120 and protocol. An audible alert 84 may be emitted by the sound emitting device 83, indicating to the user 10 that emergency notification will begin shortly. The audible alert 84 may continue emitting sound after the emergency notification process has begun in order to assist in locating the user 10 when emergency response personnel and/or companion skiers arrive. After triggering, the rescue system controller 100 may initiate a 10-second countdown before initiating the satellite communication device 70 to connect with third party communication devices, such as satellite 74 or cell phone 79 or other personal electronic device. Though a ten second countdown is depicted, the length of the delay can be shorter or longer as desired, and may be varied depending on the type or source of airbag activation, such as activation by the pulling the cable 42 or activation of the emergency notification system 120 by a sensor signal. That is, in one example, the sensor 111 may be provided to detect a condition or characteristic of the user 10 and/or the environment. The sensor 111 may be operatively coupled with the rescue system controller 100 and the rescue system controller 100 may be configured to activate the emergency notification system 120 independent of activation of the airbag system 300. Accordingly, in some examples, the sensor 111 may directly activate the emergency notification system 120. In some examples, the sensor 111 configured to detect temperature, vibration, acceleration, impact, water presence, and the like, may be used. Accordingly, in instances where a user 10 experiences an emergency such as an avalanche and is unable to trigger the airbag system 300, the emergency notification system 120 may be activated in order to ensure the safety of the user.

As shown in FIG. 6B, after the countdown sequence has finished, the communication device 70 establishes a connection to a satellite network having at least one satellite 74. In some example, the communication device 70 may also or instead connect to a cell phone 79 such as a cell phone of a companion skier or other local user. In the case of connection with the satellite network 74, the system may be configured to facilitate connection between the communication device 70 and third party device 76. In some examples, the third party device 76 may be a call center configured to receive communication from the emergency notification system 120. In other examples, the third party device 76 may be a communication device in close proximity capable of contacting and dispatching emergency responders 77.

In some examples, the third party device 76 may be an emergency dispatch system configured to operate on a separate communication network and work in conjunction with emergency responders 77, such as search and rescue teams, paramedics, and the like. An emergency message 75 from the rescue system controller 100 is transmitted to the satellite 74, which is relayed to the third party device 76. In some examples, the message 75 may be a data signal from the rescue system controller 100 and may be transmitted to a third party communication device. In a preferred example the emergency message 75 may be repeatedly transmitted until receipt of the message 75 is acknowledged, such as by a confirmation signal or message. The emergency message 75 may contain location of the user 10 as determined by the location device 114, and may optionally contain user biological or identification information such as weight, height, sex, medical history, health insurance information, and other relevant user data. This information may be stored in storage device 102, and may be used to aid in recovery and medical treatment of the user 10.

With continuing reference to FIG. 6B, the emergency message 75 transmitted across the, for example, satellite network 74 is relayed to a third party device 76, such as a call center, configured to receive and act upon such a message. Upon receiving the emergency message 75, the third party device 76 (e.g., call center) may notify emergency responders 77. The call center 76 may communicate relevant information regarding the incident and user location as well as any auxiliary user information transmitted with the emergency message. This gives emergency responders 77 the ability to better assemble and dispatch a rescue team. Upon receipt of the message, the emergency responders 77 can deploy to the accident location to find, treat, and recover the user 10. While notifying emergency responders 77, in some examples the third party device 76 may also to attempt to establish two-way communication with the user 10 at step 816, discussed below with respect to FIG. 8. As discussed above, the communication device 70 may be configured to communicate over known channels with a pre-existing communication networks. Further, the communication device 70 may be configured to directly communicate on and transmit data, such as the message 75, directly to emergency response personnel, such as emergency responders 77, without an intermediate third party device 76.

Turning now to FIG. 7, operation protocol 700 of an emergency notification method performed by a rescue or emergency notification system 120 according to one example is shown. When a user, such as the user 10 discussed above with respect to FIG. 1, experiences an emergency, they may trigger the airbag system 300 of FIG. 3. In operation, the rescue system controller 100 may activate the emergency notification system 120 to emit the audible alert 84 and activate the communication device 70 as discussed above. In operation 704 the emergency notification system 120 is powered on. During operation 706, the emergency notification system 120 monitors the switch 82. In operation 708 if the switch 82 has been activated, the operation protocol 700 proceeds to operation 709. If in the switch is not activated in operation 708, the operation protocol 700 returns to operation 706 to monitor the switch 82.

When the switch has been activated in operation 709 the emergency notification system 700 is activated. Upon activation, the emergency notification system 120 begins the countdown sequence begins in operation 710. As depicted in FIG. 6A and discussed above, the countdown sequence may be any suitable time period. In one example the countdown sequence may be 10 seconds. In operation 712 the emergency notification system 120 emits the audible alert 84. During operation 714, the rescue system controller 100 monitors the countdown sequence. Upon expiration of the countdown, the operation protocol 700 proceeds to operation 716. If the countdown sequence has not expired, operation protocol 700 returns to operation 712 and continues emitting the audible alert 84.

In operation 716, the rescue system controller 100 determines whether the emergency notification system 120 has been deactivated or canceled. In some examples, the deactivation may be performed by deactivation of the communication device 70 such as by switch, lever, cable, or the like. In some examples, the emergency notification system 120 may be deactivated when it is deployed by accident, the user 10 has recovered or no longer needs assistance, and/or emergency responders 77 have arrived. In some examples, the emergency notification system 120 may be deactivated by operating the switch 82 using airbag trigger 40. In other examples, the switch 82 may be operated directly, such as manually sliding the switch 82 and/or the cable 42 to deactivate the emergency notification system 120.

In operation 716, when the rescue system controller 100 determines that the emergency notification system 120 has not been canceled, the operation protocol 700 proceeds to operation 718 to connect with a communication device 76 of a third party. In some examples, the third party may be another skier, outdoor enthusiast, or companion of the user 10, and the emergency notification system 700 may connect to a third party's cell phone, such as the cell phone 79 in FIG. 6. In other examples, the third party device 76 may be a call center specifically configured to receive message and information from the emergency notification system 700. Operation 718 is described in more detail below with respect to FIG. 8.

Turning to FIG. 8, additional operation protocol steps 800 for connecting with the third party device in operation 718 will be described. In operation 804, the emergency notification system 120 determines if there is a local third party. If a third party is present, the protocol 800 proceeds to operation 806 to activate the short-range transceiver, such as the short-range transceiver 117 discussed above with respect to FIG. 5. Upon activation of the short-range transceiver, the emergency notification system 120 connects with the local third party device in operation 808. If no third party device is present, the protocol 800 proceeds to operation 810 to determine if there are remote users.

In operation 810, the emergency notification system 120 determines if there is a remote third party device. If a remote third party device is present, the protocol 800 proceeds to operation 812 to activate the long-range transceiver, such as the long-range transceiver 115 discussed above with respect to FIG. 5. Upon activation of the long-range transceiver, the emergency notification system 120 connects with the remote third party device in operation 814. If no remote third party device is present, the protocol 800 proceeds to operation 816 to determine whether two-way communication is possible.

In operation 816, the emergency notification system 120, upon connection with a local user in operation 808 or a remote user in operation 814, determines if two-way communication is possible. If two-way communication is possible, the emergency notification system 120 establishes two-way communication in operation 818. If two-way communication is not possible, the protocol 800 proceeds to operation 820 and ends. Upon completion of operation 718, the operation protocol 700 in FIG. 7 proceeds to operation 720.

Returning to FIG. 7, after connecting to the third party device in operation 718, the operation protocol 700 proceeds to operation 720 to transmit the message to the third party device. As discussed above, the message, such as the message 75 discussed above in FIG. 6, may include the location information determined by the location device, such as the location device 114 discussed above. In some examples, the message may include biological or identifying information about the user 10. In operation 722, upon transmitting the message to the third party device, the third party device may dispatch emergency responders based on the information in the message. In operation 724, the emergency notification system 120 determines if the emergency notification system 120 has been cancelled or otherwise deactivated. If the emergency notification system 120 has not been canceled, the operation protocol 700 returns to operation 720 to transmit the message. Accordingly, the emergency notification system 120 may repeatedly transmit the message to the third party device until the emergency notification system 120 has been canceled or deactivated. If the emergency notification system 120 has been canceled, the operation protocol 700 ends at operation 726.

As discussed above, when the message 75 is transmitted to the third party device, the transceiver 117 may also communicate location information (e.g. GPS or triangulation data) to one or more smartphones 79 carried by companion skiers or other local users. In the instance where user companions are nearby and not incapacitated by the incident, this can enable more immediate response to the affected user 10 by helping companion skiers to quickly locate the user 10. A shortened response time is very important to the ultimate survival of a buried or injured skier, as survival rates drop quickly with time.

As set forth above in examples, the disclosed technology overcomes the limitations of existing airbag backpacks, vests, and avalanche beacons and transceivers by providing an emergency notification system coupled to the airbag system. In particular, since the emergency notification system and protocol may automatically begin when the user 10 determines an avalanche has begun and triggers airbag deployment. In this way the notification protocol begins very early in the avalanche progression, automatically notifying third party devices of the location of the user 10 and enabling the third party device(s) to respond to the user location and/or dispatch emergency responders. Accordingly, the location information determined by the location device 114 may in some examples be considered rescue location information. Accordingly, even if the user 10 is unresponsive help may be dispatched. Since it is well documented that quicker response time results in higher rates of survival, the backpack disclosed herein may significantly minimize the emergency response time and maximize user survival.

It is noted that the backpack as presently disclosed is not limited to use in backcountry skiing or snowboarding. The advantages of such an airbag-equipped backpack discussed above can apply to any activity which is being practiced in a location where avalanche and snowslides may potentially occur, including within the boundary of a ski resort or along Nordic skiing, cross-country, and snowshoeing trails.

The technology described herein may be partially implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the examples of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the claimed invention. Implementations may include a computer program product that provides a non-transitory computer program storage medium readable by a computer system and encoding a computer program. It should further be understood that the described technology may be employed in special purpose devices independent of standard network, desktop, or personal computing devices.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A survival backpack comprising
an airbag system, the airbag system having at least one airbag, an airbag trigger that deploys the airbag when actuated, a communication device, and a rescue system controller; wherein
the communication device is operatively connected to the rescue system controller and comprises at least one transceiver configured to transmit and receive a data signal;
the rescue system controller is connected to the airbag trigger and configured to identify when the airbag trigger is actuated; and
upon activation of the airbag system by a user actuating the airbag trigger, the rescue system controller causes the communication device to transmit the data signal for reception by a third party communication device.

2. The backpack of claim 1 further comprising a location device operatively connected to the rescue system controller and configured to determine a location of the user.

3. The backpack of claim 2, wherein the data signal includes a predefined message comprising the location.

4. The backpack of claim 2, wherein the data signal includes a predefined message comprising biological or identifying information about the user.

5. The backpack of claim 2, wherein the location device determines the location of the user by one of a triangulation algorithm or a global positioning system satellite network.

6. The backpack of claim 1, wherein the at least one transceiver is a long-range transceiver configured to communicate with one of a satellite network, a radio network, and a telephone network.

7. The backpack of claim 1, wherein the at least one transceiver is a short-range transceiver configured to communicate with a personal electronic device.

8. The backpack of claim 7, wherein the at least one transceiver uses a local area wireless technology.

9. The backpack of claim 1, wherein
the data signal is a voice data signal; and
the communication device is configured to establish a voice data connection with the third party communication device.

10. The backpack of claim 1, wherein the communication device is configured to receive a confirmation signal from the third party communication device.

11. The backpack of claim 1, wherein the rescue system controller controls the transceiver to transmit the data signal to the third party communication device periodically.

12. The backpack of claim 1, wherein the airbag system further comprises a canister containing a compressed gas therein;
a trigger mechanism as part of the airbag trigger operably coupled to the canister;
a trigger switch coupled to the trigger mechanism and switchably connected to the rescue system controller; and
a sound emitting device connected to the rescue system controller;
wherein upon activation of the trigger mechanism by the user,
the at least one airbag inflates with the compressed gas from the canister;
the trigger switch connects with the rescue system controller; and
the rescue system controller responds to the connection with the trigger switch by actuating the sound emitting device to emit a sound.

13. The backpack of claim 12, wherein the trigger mechanism is coupled to the trigger switch by a trigger cable.

14. The backpack of claim 12, wherein the trigger mechanism is coupled to the trigger switch by a wireless communication technology.

15. The backpack of claim 12, wherein
the airbag system further comprises a sensor configured to detect one or more of acceleration, vibration, and temperature; and
the rescue system controller causes the transmission by the communication device, upon receipt of a signal from the sensor indicating detection of a threshold value.

16. The backpack of claim 1, wherein the airbag system further comprises a cancellation mechanism, wherein upon activation of the cancellation mechanism by the user, the communication device is deactivated.

17. The backpack of claim 1, wherein the airbag system is one of impact-resistant, freeze-resistant, and water-resistant.

18. An emergency notification method performed by an emergency notification system in a survival backpack, the backpack having
a deployable airbag;
an airbag trigger that deploys the airbag when actuated;
a rescue system controller;
an activation switch coupled to the airbag trigger and switchably connected to the rescue system controller;
a sound emitting device connected to the rescue system controller;
a communication device connected to the rescue system controller and having at least one transceiver configured to establish a connection to a third party communication device;
the emergency notification method comprising
determining by the rescue system controller in response to connection with the activation switch if the airbag has been activated; and
when the airbag has been activated, controlling by the rescue system controller the communication device to establish a connection with the third party communication device.

19. The method of claim 18, wherein when the airbag is activated, actuating the sound emitting device by the rescue system controller to emit an audible alert.

20. The method of claim 18, wherein upon establishing the connection, the method further comprises controlling the communication device by the rescue system controller to transmit the at least one message to the third party communication device.

21. The method of claim 18, wherein the backpack further comprises
a location device connected to the rescue system controller and configured to determine a location of the user; and
a storage device connected to the rescue system controller and configured to store at least one of the location and at least one message; wherein
the at least one message includes instructions for the third party communication device to communicate rescue location information based on the detected location to an emergency dispatch system over a separate communication network.

22. The method of claim 18, wherein upon connection with the activation switch, the rescue system controller begins a countdown sequence.

23. The method of claim 22, wherein when the countdown sequence has completed, the method further comprises controlling the communication device by the rescue system controller to establish the connection to the third party communication device.
